(19) United States
(12) Patent Application Publication
(10) Pub. No.: US 2019/0025104 A1
(43) Pub. Date: Jan. 24, 2019

(54) THERMAL FLOWMETER AND FLOW RATE CORRECTION METHOD

(71) Applicant: AZBIL CORPORATION, Chiyoda-ku (JP)

(72) Inventors: Yuusei YANAGAWA, Chiyoda-ku (JP); Yoshio YAMAZAKI, Chiyoda-ku (JP); Shinsuke MATSUNAGA, Chiyoda-ku (JP); Shigeru AOSHIMA, Chiyoda-ku (JP)

(73) Assignee: AZBIL CORPORATION, Chiyoda-ku (JP)

(21) Appl. No.: 16/037,081

(22) Filed: Jul. 17, 2018

(30) Foreign Application Priority Data
Jul. 19, 2017 (JP) 2017-139910

(51) Int. Cl. G01F 1/69; G01F 1/696

(52) U.S. Cl. CPC G01F 1/69; G01F 1/696

(57) ABSTRACT

A thermal flowmeter includes a first thermal resistance element that detects a first temperature of a fluid, a second thermal resistance element disposed downstream to detect a second temperature of the fluid, a control unit that causes the second thermal resistance element to heat to make the second temperature higher than the first temperature by a fixed value, a power measurement unit that measures a power applied to the second thermal resistance element, a power conversion unit that multiplies the power measured by the power measurement unit, by a constant uniquely determined depending on the fluid, thereby converting the power to a power required when the fluid is water, and a flow rate calculation unit that calculates a flow rate of the fluid, by converting the power converted by the power conversion unit to a value of the flow rate, using a flow rate conversion characteristic formula applicable to water.

### CROSS-REFERENCE TO RELATED APPLICATIONS

The present application is based on and claims priority to Japanese Application No. 2017-139910, filed Jul. 19, 2017, the entire contents of which are incorporated herein by reference.

### BACKGROUND

### 1. Field

The present disclosure relates to a thermal flowmeter that calculates a flow rate of a fluid on the basis of power applied to a heater, by measuring the temperature of the fluid at an upstream point and a downstream point of a pipe, and controlling the heater so as to maintain a temperature difference between the two points at a constant level.

### 2. Description of the Related Art

In the known thermal flowmeters, correction has to be performed for each type of the fluid, because the thermal characteristics differ depending on the type of the fluid, as described, for example, in Japanese Unexamined Patent Application Publication No. 11-132812. With existing thermal flowmeters, the relation between an actual flow rate and a sensor output has to be acquired for each type of fluid at multiple measurement points for correction to determine a correction coefficient. Thus, the determination process of the correction coefficient is complicated.

### SUMMARY

Accordingly, the present disclosure provides a thermal flowmeter and a flow rate correction method with which the flow rate is able to be corrected through a simple process.

A thermal flowmeter according to an aspect of the present disclosure includes a pipe through which a fluid to be measured is caused to flow, a first thermal resistance element disposed on the pipe and configured to detect a first temperature of the fluid to be measured, a second thermal resistance element disposed on the pipe at a position downstream of the first thermal resistance element and configured to detect a second temperature of the fluid to be measured, a control unit configured to cause the second thermal resistance element to heat by outputting a voltage to make the second temperature higher than the first temperature by a fixed value, a power measurement unit configured to measure a power to be applied to the second thermal resistance element, a power conversion unit configured to convert the power measured by the power measurement unit to a power assumed to be required when the fluid is water, by multiplying the power measured by the power measurement unit by a constant uniquely determined depending on a type of the fluid to be measured, and a flow rate calculation unit configured to calculate a flow rate of the fluid to be measured, by converting the power converted by the power conversion unit to a value of the flow rate, using a flow rate conversion characteristic formula applicable when the fluid is water.

In the thermal flowmeter configured as above, the constant may be determined through an experiment performed beforehand, on a basis of a power obtained by backward calculation based on an inverse function of the flow rate conversion characteristic formula, from an actual flow rate of the fluid to be measured and a flow rate measured by the thermal flowmeter.

A flow rate correction method according to another aspect of the present disclosure is a method for a thermal flowmeter including a pipe through which a fluid to be measured is caused to flow, a first thermal resistance element disposed on the pipe and configured to detect a first temperature of the fluid to be measured, and a second thermal resistance element disposed on the pipe at a position downstream of the first thermal resistance element and configured to detect a second temperature of the fluid to be measured. The flow rate correction method includes causing the second thermal resistance element to heat by outputting a voltage to make the second temperature higher than the first temperature by a fixed value, measuring a power to be applied to the second thermal resistance element, converting the power measured in the measuring of the power to a power assumed to be required when the fluid is water, by multiplying the power measured in the measuring the power by a constant uniquely determined depending on a type of the fluid to be measured, and calculating a flow rate of the fluid to be measured, by converting the power converted in the converting the power to a value of the flow rate, using a flow rate conversion characteristic formula applicable when the fluid is water.

According to the aspects of the disclosure, the flow rate is corrected through a simple process of multiplying the power measured by the power measurement unit by a constant uniquely determined depending on the type of the fluid to be measured, thereby converting the power to a power assumed to be required when the fluid is water, and converting the power converted as above to a value of the flow rate, using a flow rate conversion characteristic formula applicable when the fluid is water.

### BRIEF DESCRIPTION OF THE DRAWINGS

FIG. 1 is a block diagram illustrating a configuration of a thermal flowmeter according to an embodiment of the present disclosure;

FIG. 2 is a flowchart describing operations of a temperature acquisition unit, a subtractor, a PID control calculation unit, and a control output unit of the thermal flowmeter according to the embodiment of the present disclosure;

FIG. 3 is a flowchart describing operations of a power measurement unit, a power conversion unit, and a flow rate calculation unit of the thermal flowmeter according to the embodiment of the present disclosure; and

FIG. 4 is a graph illustrating an example of a relation between power and flow rate in the thermal flowmeter.

### DETAILED DESCRIPTION

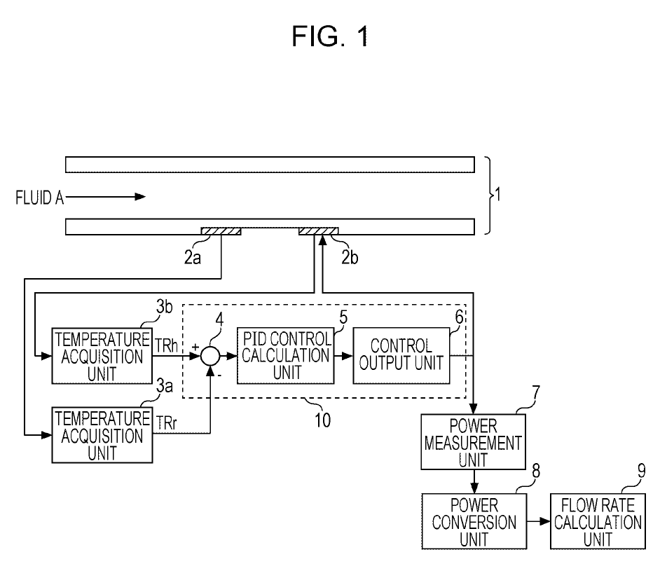

Hereafter, an embodiment of the present disclosure is described, with reference to the drawings. FIG. 1 is a block diagram illustrating a configuration of a thermal flowmeter according to an embodiment of the present disclosure. The thermal flowmeter includes a pipe 1, for example, made of glass through which a fluid to be measured can flow, a first thermal resistance element 2a, for example, formed of platinum and disposed on the pipe 1, a second thermal resistance element 2b (heater), for example, formed of platinum and disposed on the pipe 1 at a position downstream of the first thermal resistance element 2a, a temperature acquisition unit 3a that acquires a temperature TRr of the fluid detected by the thermal resistance element 2a, a temperature acquisition unit 3b that acquires a temperature TRh detected by the thermal resistance element 2b, a subtractor 4 that subtracts the temperature TRr from the temperature TRh, a PID control unit 5 that calculates an operation amount so as to make a temperature difference (TRh-TRr) a fixed value, a control output unit 6 that causes the second thermal resistance element 2b to heat by outputting a voltage according to the operation amount calculated by the PID control calculation unit 5a, a power measurement unit 7 that measures the power to be applied to the second thermal resistance element 2b, a power conversion unit 8 that converts the power measured by the power measurement unit 7 to a power assumed to be required when the fluid is water, by multiplying the power measured by the power measurement unit 7 by a constant uniquely determined depending on a type of the fluid to be measured, and a flow rate calculation unit 9 that calculates a flow rate of the fluid to be measured, by converting the power converted by the power conversion unit 8 to a value of the flow rate, using a flow rate conversion characteristic formula applicable when the fluid is water. The subtractor 4, the PID control calculation unit 5, and the control output unit 6 constitute a control unit 10.

The thermal resistance elements 2a and 2b are each formed on a silicon wafer. The thermal resistance element 2a is fixed to the pipe 1 by bonding the silicon wafer to the pipe 1 with the face of the silicon wafer, on which the thermal resistance element 2a is formed, opposed to the outer wall of the pipe 1. The thermal resistance element 2b is also fixed in the same way as the thermal resistance element 2a. In the example illustrated in FIG. 1, the thermal resistance elements 2a and 2b are attached to a position where the wall thickness of the pipe 1 is made thinner.

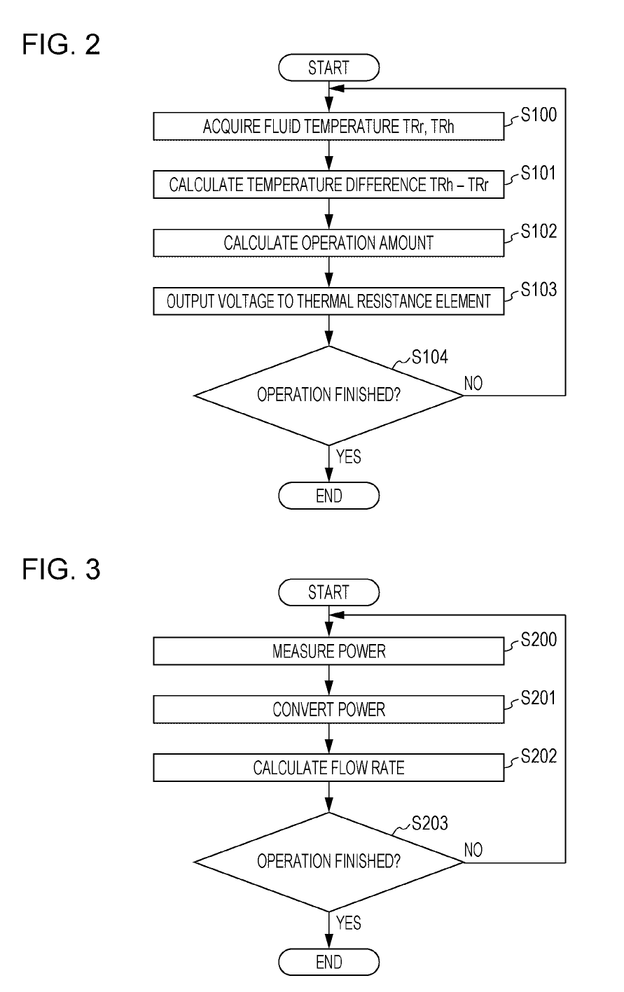

Hereunder, an operation of the thermal flowmeter according to the embodiment is described. FIG. 2 is a flowchart describing operations of the temperature acquisition units 3a and 3b, the subtractor 4, the PID control calculation unit 5, and the control output unit 6.

The temperature acquisition units 3a and 3b respectively acquire temperature TRr, TRh of a fluid A flowing through the pipe 1 (step S100 in FIG. 2). More specifically, the temperature acquisition units 3a and 3b respectively detect a resistance of the thermal resistance elements 2a and 2b, and acquire the temperature TRr, TRh of the fluid A, on the basis of a relation between the resistance and the temperature.

The subtractor 4 subtracts the temperature TRr of the fluid A on an upstream side, from the temperature TRh on a downstream side (step S101 in FIG. 2).

The PID control calculation unit 5 calculates the operation amount so as to make the temperature difference (TRh-TRr) calculated by the subtractor 4 a fixed value (target value of control, for example, 10° C.) (step S102 in FIG. 2).

The control output unit 6 applies a voltage to the thermal resistance element 2b in accordance with the operation amount calculated by the PID control calculation unit 5, thereby causing the thermal resistance element 2b to heat (step S103 in FIG. 2).

Thus, the operations of steps S100 to S103 are executed in a predetermined control cycle until the operation of the thermal flowmeter is finished (YES at step S104 in FIG. 2) to perform the PID control so as to constantly make the temperature TRh of the fluid A on the downstream side higher than the temperature TRr on the upstream side by the fixed value.

FIG. 3 is a flowchart describing operations of the power measurement unit 7, the power conversion unit 8, and the flow rate calculation unit 9. The power measurement unit 7 measures a power Q to be applied to the thermal resistance element 2b (step S200 in FIG. 3). The power measurement unit 7 calculates the power Q to be applied to the thermal resistance element 2b, for example, with an equation given below on the basis of a voltage V applied to the thermal resistance element 2b and a resistance Rh of the thermal resistance element 2b.

Q=V²/Rh (1)

The power Q required for constantly keeping the temperature TRh of the fluid A on the downstream side higher than the temperature TRr on the upstream side by the fixed value can be obtained as above.

Then the power conversion unit 8 multiplies the power Q measured by the power measurement unit 7 by a constant α_{A}, which is uniquely determined depending on the type of the fluid A to be measured, to thereby convert the power Q to a power that would be required when the fluid is water (step S201 in FIG. 3).

The constant α_{A} can be obtained as follows. Here, it is assumed that a flow rate conversion characteristic formula f for obtaining a flow rate F_{H2O} of water from a power Q_{H2O} measured by the power measurement unit 7 when the fluid is water is already known through actual measurement.

F_{H2O}=f(Q_{H2O}) (2)

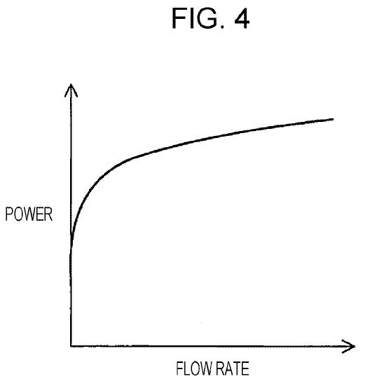

FIG. 4 is a graph illustrating an example of a relation between the power and the flow rate in the thermal flowmeter. The flow rate conversion characteristic formula f applicable to water can be determined by obtaining the relation as illustrated in FIG. 4 between the power Q_{H2O} and the actual flow rate F_{H2O} of water.

It is also assumed that an actual flow rate Fₐ of the fluid A to be measured and a measured flow rate Fₘ obtained by the thermal flowmeter according to this embodiment are already known through experiments. However, to obtain the measured flow rate Fₘ for the calculation of the constant α_{A}, the power Q measured by the power measurement unit 7 may be directly substituted into the flow rate conversion characteristic formula f, to thereby obtain the measured flow rate Fₘ from f (Q) instead of executing the power conversion of step S201.

A power Qₐ corresponding to a flow rate Fₐ when the fluid is water can be obtained from the equation (3) given below.

Qₐ=f⁻¹(Fₐ) (3)

Here, f⁻¹ is the inners function of the flow rate conversion characteristic formula f.

In addition, the power Qₘ corresponding to the flow rate Fₘ when the fluid is other than water can be obtained from the equation (4) given below.

Qₘ=f⁻¹(Fₘ) (4)

As above, the power Qₐ, Qₘ can be calculated backward using the inverse function f⁻¹ of the flow rate conversion characteristic formula f. An approximation formula can be established as below with respect to the power Qₐ, Qₘ, and therefore the constant α_{A} can be determined in advance by obtaining, through experiments, the flow rate Fₐ, Fₘ, of the fluid A to be measured.

Qₐ≈α_{A}Qₘ (5)

By determining, as above, in advance the constant an α_{A} with respect to the fluid A to be measured, the power Q measured by the power measurement unit 7 can be converted to the power required when the fluid is water, by multiplying the power Q by the constant α_{A}.

The flow rate calculation unit 9 converts a power α_{A}Q converted by the power conversion unit 8 to the value of the flow rate, using the flow rate conversion characteristic formula f, to thereby calculate a flow rate F of the fluid A to be measured (step S202 in FIG. 3).

F=f(α_{A}Q) (6)

Thus, the operations of steps S200 to S202 are executed at predetermined time intervals until the operation of the thermal flowmeter is finished (YES at step S203 in FIG. 3).

Since the relation between the actual flow rate and the flow rate measured by the thermal flowmeter according to this embodiment is non-linear, it is difficult to directly correct the measured flow rate. In this embodiment, accordingly, the power Q measured by the power measurement unit 7 is corrected so as to indirectly correct the flow rate. As a result, with the method according to this embodiment, the actual flow rate can be approximately obtained through a simple process.

Here, a supplementary description is given about the basis for the effectiveness of the present disclosure. The power Q in the thermal flowmeter configured as FIG. 1 can be expressed as follows on the basis of thermal conduction characteristics and an analytic approximation of the flow of the fluid.

Q=kF^{α} (7)

k denotes a coefficient indicating the characteristics of the fluid (thermal conductivity, Reynolds number, density, and so forth), F denotes the flow velocity of the fluid, and α denotes an exponential coefficient for the flow velocity (coefficient based on a physical structure of a flow path and a sensor system, approximately ½). The inverse function f⁻¹ of the flow rate conversion characteristic formula f can be expressed as follows.

F=f⁻¹( )=(Q/k)^{-α} (8)

When the fluid is other than water, the physical structure of the flow path is the same, but the characteristics of the fluid are different (an impact of thermal conductivity of the fluid is important in the first approximation), and therefore it may be assumed that the coefficient α is the same as that of water, and the coefficient k is different from that of water. The coefficient k of the fluid other than water will hereinafter be expressed as kₘ. The flow velocity Fₘ of the fluid other than water can be expressed as follows.

Fₘ=(Qₘ/kₘ)^{-α} (9)

Then the power required to allow water and the fluid other than water to flow at the same velocity is measured. In other words, Q and Qₘ corresponding to the case of F=Fₘ is measured. In this case, the following equation can be established from the equation (8)/and the equation (9).

F/Fₘ=1((Q/k)^{-α})/((Qₘ/kₘ)^{-α}) (10)

From the equation (10) above, the following equation can be obtained.

Q/k=Qₘ/kₘ (11)

Since the power Q required for water, the coefficient k representing the characteristics of water, and the power Qₘ required for the fluid other than water are available from actual measurement, the coefficient kₘ representing the characteristics of the fluid other than water can be obtained.

From the equation (11) above, the following equation (12) can be obtained.

Q=(Qₘ/kₘ)×k (12)

Accordingly, the flow velocity F calculated from the power Q obtained by multiplying the power Qₘ for the fluid other than water by (k/kₘ) can be construed as an approximate value of the flow velocity of the fluid other than water. The value (k/kₘ) corresponds to the constant α_{A}. Therefore, the actual flow rate can be approximately obtained through a simple process.

Although the constant α_{A} is a fixed value in this embodiment, the constant α_{A} may be variable, depending on the power Q measured by the power measurement unit 7. For example, the constant α_{A} in the equation (6) may be substituted with a constant α_{A}(Q), as expressed by the following equation (13).

α_{A}(Q)=α_{A}(1−exp(−βQ)) (13)

Here, the coefficient β is a value obtained from experimental values.

Out of the components of the thermal flowmeter according to this embodiment, at least the subtractor 4, the PID control calculation unit 5, the power conversion unit 8, and the flow rate calculation unit 9 can be realized by a computer including a CPU or other processing circuitry, a storage device, and an interface with outside, and a program for controlling the mentioned hardware resources. The flow rate correction method performed by the thermal flowmeter can be realized, when the CPU executes the operations according to the foregoing embodiment, in accordance with the program stored in the storage device.

The present disclosure is applicable to a thermal flowmeter.

What is claimed is:

1. A thermal flowmeter comprising:
a pipe through which a fluid to be measured is caused to flow;
a first thermal resistance element disposed on the pipe and configured to detect a first temperature of the fluid to be measured;
a second thermal resistance element disposed on the pipe at a position downstream of the first thermal resistance element and configured to detect a second temperature of the fluid to be measured;
a control unit configured to cause the second thermal resistance element to heat by outputting a voltage to make the second temperature higher than the first temperature by a fixed value;
a power measurement unit configured to measure a power to be applied to the second thermal resistance element;
a power conversion unit configured to convert the power measured by the power measurement unit to a power assumed to be required when the fluid is water, by multiplying the power measured by the power measurement unit by a constant uniquely determined depending on a type of the fluid to be measured; and
a flow rate calculation unit configured to calculate a flow rate of the fluid to be measured, by converting the power converted by the power conversion unit to a value of the flow rate, using a flow rate conversion characteristic formula applicable when the fluid is water.

2. The thermal flowmeter according to claim 1, wherein
the constant is determined through an experiment performed beforehand, on a basis of a power obtained by backward calculation based on an inverse function of the flow rate conversion characteristic formula, from an actual flow rate of the fluid to be measured and a flow rate measured by the thermal flowmeter.

3. A flow rate correction method for a thermal flowmeter including a pipe through which a fluid to be measured is caused to flow, a first thermal resistance element disposed on the pipe and configured to detect a first temperature of the fluid to be measured, and a second thermal resistance element disposed on the pipe at a position downstream of the first thermal resistance element and configured to detect a second temperature of the fluid to be measured, the flow rate correction method comprising:
causing the second thermal resistance element to heat by outputting a voltage to make the second temperature higher than the first temperature by a fixed value;
measuring a power to be applied to the second thermal resistance element;
converting the power measured in the measuring of the power to a power assumed to be required when the fluid is water, by multiplying the power measured in the measuring the power by a constant uniquely determined depending on a type of the fluid to be measured; and
calculating a flow rate of the fluid to be measured, by converting the power converted in the converting the power to a value of the flow rate, using a flow rate conversion characteristic formula applicable when the fluid is water.

4. The method according to claim 3, wherein
the constant is determined through an experiment performed beforehand, on a basis of a power obtained by backward calculation based on an inverse function of the flow rate conversion characteristic formula, from an actual flow rate of the fluid to be measured and a flow rate measured by the thermal flowmeter.
